(19) United States
(12) Patent Application Publication
(10) Pub. No.: US 2017/0158919 A1
(43) Pub. Date: Jun. 8, 2017

(54) SHEET TO BE PASTED ON ROAD SURFACE, FLOOR, OR WALL SURFACE AND SET FOR FORMING SHEET TO BE PASTED ON ROAD SURFACE, FLOOR, OR WALL SURFACE

(71) Applicant: FUJIFILM CORPORATION, Tokyo (JP)

(72) Inventors: Masahiko NORITSUNE, Shizuoka (JP); Toshiyuki KATAGIRI, Shizuoka (JP); Yoshihiko SANO, Shizuoka (JP)

(21) Appl. No.: 15/435,304

(22) Filed: Feb. 17, 2017

Related U.S. Application Data
(63) Continuation of application No. PCT/JP2015/074028, filed on Aug. 26, 2015.

(30) Foreign Application Priority Data
Sep. 4, 2014 (JP) 2014-180149

(51) Int. Cl. C09J 7/02; G09F 19/22; C09J 7/04

(52) U.S. Cl. CPC C09J 7/0246; C09J 7/0271; C09J 7/045; G09F 19/22; C09J 121/00

(57) ABSTRACT

An object of the invention is to provide a sheet for application to a road surface, a floor, or a wall surface of which following properties to a pasted road surface, a pasted floor, or a pasted wall surface are excellent, and of which strength is excellent and a set for forming a sheet for application to a road surface, a floor, or a wall surface, which can easily form the sheet.

The sheet for application to a road surface, a floor, or a wall surface according to the invention has a pressure sensitive adhesive layer; a base material layer that is in contact with the pressure sensitive adhesive layer and of which a tensile elastic modulus is 150 MPa or less; and a protective layer of which a tensile elastic modulus is 1,000 MPa or greater, in this order. A set for forming a sheet for application to a road surface, a floor, or a wall surface according to the invention includes: an image forming sheet including a peeling layer, a pressure sensitive adhesive layer, a base material layer that is in contact with the pressure sensitive adhesive layer and of which a tensile elastic modulus is 150 MPa or less, and an image forming layer, in this order; and a protective sheet including a peeling layer, an adhesive layer, and a protective layer of which a tensile elastic modulus is 1,000 MPa or greater, in this order.

### CROSS-REFERENCE TO RELATED APPLICATIONS

This application is a Continuation of International Application No. PCT/JP2015/074028 filed on Aug. 26, 2015, which claims priority to Japanese Patent Application No. 2014-180149 filed on Sep. 4, 2014. The entire contents of these applications are incorporated herein by reference.

### BACKGROUND OF THE INVENTION

1. Field of the Invention

The invention relates to a sheet for application to a road surface, a floor, or a wall surface, and set for forming sheet for application to a road surface, a floor, or a wall surface.

2. Description of the Related Art

A decorative sheet that is pasted on a floor or a wall surface indoor and outdoor and on a road surface of a road, a parking lot, or the like, and that provides colors, patterns, or characters on a road surface, a floor, or a wall surface for the purpose of indicating information such as advertising, direction indication, traffic flags, and a guidepost, is suitably used.

As the decorative sheet in the related art, sheets disclosed in JP2001-295454A, JP2010-145903A, JP2013-237214A, and JP2014-85640A are known.

In JP2001-295454A, disclosed is an adhesive sheet including a base layer, a protective layer disposed on a front surface of the base layer, and an adhesive layer disposed on a back surface of the base layer, in which the protective layer contains a front surface modifying agent that modifies a front surface of the protective layer, a hardened resin, and inorganic oxide particles. The adhesive sheet further includes a cushion layer that contains an elastomer and that is disposed between the base layer and the protective layer.

In JP2010-145903A, disclosed is a floor marking sheet that is laid on a floor and performs advertising, an annunciator, or floor decoration, in which a rubber sheet provided with an adhesive layer on a layer opposite to a surface that is closely attached to the floor and a sheet-like media on which patterns for advertising, a guide sign, or decoration are recorded are laminated in a state in which a pressure sensitive adhesive layer provided on one surface of the media and the adhesive layer of the rubber sheet face with each other and a protective layer that consists of a resin having incombustibility is provided on the other surface of the media.

In JP2013-237214A, disclosed is a decorative sheet including a first beads coating layer consisting of a resin and particles of which a median of a particle diameter is in the range of 20 μm to 60 μm, a second beads coating layer consisting of a resin laminated on the first beads coating layer and particles of which a median of a particle diameter is in the range of 20 μm to 60 μm, a design layer, and an adhesive layer.

In JP2014-85640A, disclosed is a sheet for floor marking including a light guide sheet that consists of a resin having flexibility, a light guide layer of which an inner portion guides light, and a design layer in which information is drawn.

### SUMMARY OF THE INVENTION

The present inventors diligently conducted research and, as a result, found that following properties to a pasted surface and strength of the sheet itself were not sufficiently compatible with each other, in decorative sheets such as a floor sign in the related art which are disclosed in JP2001-295454A, JP2010-145903A, JP2013-237214A, and JP2014-85640A.

An object of the invention is to provide a sheet for application to a road surface, a floor, or a wall surface of which following properties to a pasted road surface, a pasted floor, or a pasted wall surface are excellent and of which strength is excellent, and a set for forming a sheet for application to a road surface, a floor, or a wall surface, which can easily form the sheet.

The object can be achieved by means described in <1> or <14>, and the means is described below together with <2> to <13> which are preferable embodiment.

<1> A sheet for application to a road surface, a floor, or a wall surface, comprising: a pressure sensitive adhesive layer; a base material layer that is a layer is in contact with the pressure sensitive adhesive layer and of which a tensile elastic modulus is 150 MPa or less, and a protective layer of which a tensile elastic modulus is 1,000 MPa or greater, in this order.

<2> The sheet according to <1>, in which a thickness of the base material layer is 200 to 1,000 μm.

<3> The sheet according to <1> or <2>, in which a thickness of the pressure sensitive adhesive layer is 50 to 200 μm.

<4> The sheet according to any one of <1> to <3>, in which a material of the base material layer is at least one selected from the group consisting of rubber, a non-woven fabric, and a woven fabric.

<5> The sheet according to any one of <1> to <4>, further comprising: an image layer between the protective layer and the base material layer.

<6> The sheet according to <5>, further comprising: an adhesive layer between the protective layer and the image layer.

<7> The sheet according to any one of <1> to <6>, in which the protective layer has a laminate structure of two or more layers.

<8> The sheet according to any one of 1 to 7, in which a tensile elastic modulus of the base material layer is 2 to 120 MPa.

<9> The sheet according to any one of <1> to <8>, in which a tensile elastic modulus of the protective layer is 2,500 to 5,000 MPa.

<10> The sheet according to any one of <1> to <9>, in which a material of the protective layer includes at least polyethylene terephthalate.

<11> The sheet according to any one of <1> to <10>, in which the protective layer includes at least a layer that consists of polyethylene terephthalate and a layer that consists of polyethylene terephthalate obtained by partially copolymerizing cyclohexanedimethanol.

<12> The sheet according to any one of <1> to <11>, in which a material of the base material layer includes non-woven fabric or woven fabric.

<13> The sheet according to any one of <1> to <12>, which is a sheet for application to a road surface or a floor.

<14> A set for forming a sheet for application to a road surface, a floor, or a wall surface, comprising: an image forming sheet including a peeling layer, a pressure sensitive adhesive layer, a base material layer that is in contact with the pressure sensitive adhesive layer and of which a tensile elastic modulus is 150 MPa or less, and an image forming layer, in this order; and a protective sheet including a peeling layer, an adhesive layer, and a protective layer of which a tensile elastic modulus is 1,000 MPa or greater, in this order.

According to the invention, it is possible to provide a sheet for application to a road surface, a floor, or a wall surface of which following properties to a pasted road surface, a pasted floor, or a pasted wall surface are excellent, and of which strength is excellent and a set for forming a sheet for application to a road surface, a floor, or a wall surface, which can easily form the sheet.

### BRIEF DESCRIPTION OF THE DRAWINGS

FIG. 1 is a diagram schematically illustrating a cross-section of an example of a sheet for application to a road surface, a floor, or a wall surface according to an embodiment of the invention.

FIG. 2 is a diagram schematically illustrating a cross-section of an example of a sheet for application to a road surface, a floor, or a wall surface according to another embodiment of the invention.

### DESCRIPTION OF THE PREFERRED EMBODIMENTS

Hereinafter, contents of the invention are described in detail. The description of configuration requirements described below is made based on representative embodiment of the invention. However, the invention is not limited to the embodiments. The expression “to” is used as a meaning of including numerical values described before and after the expression as a lower limit and an upper limit.

According to the invention, “mass %” and “weight %” have the same meaning, and “parts by mass” and “parts by weight” the same meaning.

According to the invention, a combination of two or more preferable forms is a more preferable form.

The weight-average molecular weight according to the invention is a weight-average molecular weight in terms of polystyrene measured by gel permeation chromatography (GPC) in a case where tetrahydrofuran (THF) is used as a moving bed.

### (Sheet for Application to Road Surface, Floor, or Wall Surface)

The sheet for application to a road surface, a floor, or a wall surface (hereinafter, simply referred to as the “sheet according to the invention”) has a pressure sensitive adhesive layer, a base material layer which is in contact with the pressure sensitive adhesive layer and of which a tensile elastic modulus is 150 MPa or less, and a protective layer of which a tensile elastic modulus is 1,000 MPa or greater, in this order.

In view of the above, the present inventors diligently conducted research and, as a result, found that following properties to a pasted road surface, a pasted floor, or a pasted wall surface were excellent, and strength was excellent, if the sheet according to the invention has a protective layer having a high tensile elastic modulus and a base material layer having a specific tensile elastic modulus lower than that of the protective layer that is in contact with the pressure sensitive adhesive layer, so as to conceive the invention.

The sheet according to the invention is a sheet that can be suitably pasted on a road surface made of asphalt, concrete, and the like and a floor and a wall surface indoor and outdoor made of resin, wood, concrete, and the like. The sheet according to the invention can be more suitably used as a sheet for application to a road surface or a floor.

Since the sheet according to the invention is used for advertising, direction indication, traffic flags, and/or a guidepost, the sheet according to the invention can be particularly suitably as a sheet for a so-called floor sign, which is pasted on a floor or a road surface, on which pedestrians and vehicles come and go.

### <Pressure Sensitive Adhesive Layer>

The sheet according to the invention has a pressure sensitive adhesive layer that is in contact with the base material layer.

The pressure sensitive adhesive layer is a layer having pressure sensitive adhesiveness so as to be applicated to a road surface, a floor, or a wall surface and is preferably a layer including a pressure sensitive adhesive.

As the pressure sensitive adhesive included in the pressure sensitive adhesive layer, well-known pressure sensitive adhesives can be used. Examples thereof include a vinyl polymerization-based pressure sensitive adhesive such as an acrylic pressure sensitive adhesive, a styrene-based pressure sensitive adhesive, a vinyl acetate-ethylene copolymer-based pressure sensitive adhesive, and a vinyl chloride-vinyl acetate copolymer-based pressure sensitive adhesive, a condensation polymerization-based pressure sensitive adhesive such as a polyester-based pressure sensitive adhesive, a thermosetting resin-based pressure sensitive adhesive such as an epoxy resin-based pressure sensitive adhesive, an urethane resin-based pressure sensitive adhesive, and a formalin resin-based pressure sensitive adhesive, and a silicone-based pressure sensitive adhesive.

Among these, examples thereof suitably includes a rubber-based pressure sensitive adhesive, an acrylic pressure sensitive adhesive, an urethane-based pressure sensitive adhesive, a polyester-based pressure sensitive adhesive, and/or a silicone-based-based pressure sensitive adhesive. Examples thereof more preferably include a rubber-based pressure sensitive adhesive and an acrylic pressure sensitive adhesive.

The pressure sensitive adhesive may be used singly or two or more types thereof may be used in combination.

Examples of the rubber-based pressure sensitive adhesive include a styrene-butadiene copolymer (SBR, SBS), a styrene-isoprene copolymer (SIS), an acrylonitrile-butadiene copolymer (NBR), a chloroprene polymer, and an isobutylene-isoprene copolymer (butyl rubber).

Specific examples of the acrylic pressure sensitive adhesive suitably include SK-DYNE (registered trademark) 1310, 1435, SK-DYNE 1811L, SK-DYNE 1888, SK-DYNE 2094, SK-DYNE 2096, SK-DYNE 2137, SK-DYNE 3096, and SK-DYNE 1852 manufactured by Soken Chemical & Engineering Co. Ltd., and BPS5961, BPS4622, BPS4849-40, BPS6130TF, BPS6078TF, EG354J, BPS5296, and BPS5963 manufactured by Toyochem Co., Ltd.

The acrylic pressure sensitive adhesive has low cohesive force, and thus the acrylic pressure sensitive adhesive is preferably crosslinked with a crosslinking agent. As the crosslinking agent, an isocyanate compound, an epoxy compound, an aziridine compound, and a metal chelate compound are suitably used.

In the acrylic pressure sensitive adhesive, a curing accelerator (for example, BXX3778-10 and BXX4805 manufactured by Toyochem Co., Ltd.), a curing delay agent (for example, BXX5638 manufactured by Toyochem Co., Ltd.), a curing agent (for example, BXX6269 manufactured by Toyochem Co., Ltd.), and other additives (for example, BXX6342 manufactured by Toyochem Co., Ltd.) are preferably used.

If necessary, the pressure sensitive adhesive layer may contain well-known additives, for example, a coloring agent, an antioxidant, an ultraviolet absorbing agent, a silane coupling agent, and a metal deactivator.

The thickness of the pressure sensitive adhesive layer preferably 10 to 300 μm, more preferably 30 to 250 μm, and even more preferably 50 to 200 μm. If the thickness is in the range described above, adhesiveness to a pasted surface becomes excellent and following properties to the pasted surface becomes more excellent.

The thickness of the pressure sensitive adhesive layer is preferably thinner than that of the base material layer.

### <Base Material Layer>

The sheet according to the invention is a layer which is in contact with the pressure sensitive adhesive layer and which has a base material layer of which a tensile elastic modulus is 150 MPa or less.

In the sheet according to the invention, it is important that the pressure sensitive adhesive layer and the base material layer directly come into contact with each other. If the pressure sensitive adhesive layer and the base material layer come into contact with each other, following properties of the sheet to a pasted road surface, a pasted floor, or pasted a wall surface is particularly excellent, and tear resistance of the sheet is also excellent.

The tensile elastic modulus of the base material layer according to the invention is 150 MPa or less, preferably 1 to 150 MPa, more preferably 2 to 120 MPa, and even more preferably 5 to 100 MPa. If the tensile elastic modulus is in the range described above, following properties of the pasted surface are excellent and tear resistance is also excellent.

Tensile elastic moduli of the respective layers according to the invention are calculated by performing a test in conformity with JIS K 7161.

The material of the base material layer is preferably at least one selected from the group consisting of rubber, non-woven fabric, and woven fabric. If the material has the form described above, following properties of a pasted surface becomes more excellent, and the strength becomes more excellent.

Examples of the rubber used in the base material layer include synthetic rubber such as acrylonitrile-butadiene rubber (NBR), chloroprene rubber (CR), ethylene-propylene rubber (EPT), isobutylene-isoprene rubber (IIR), chlorosulfonated polyethylene rubber (CSM), and styrene-butadiene rubber (SBR), natural rubber, silicone fluorine rubber, and urethane rubber. Among these, NBR or natural rubber is preferable, and NBR is more preferable.

As the rubber used in the base material layer, a rubber sheet is preferably used.

Examples of the non-woven fabric used in the base material layer include non-woven fabric such as polyester, nylon, polyethylene, and polylactic acid, and examples thereof preferably include non-woven fabric such as polyester.

As the woven fabric used in the base material layer, woven fabric of chemical fibers is preferable. The woven fabric may be woven fabric using fibers coated with a resin, fabric obtained by coating woven fabric with a resin, and fabric obtained by laminating a resin film on woven fabric. Among these, as the woven fabric, tarpaulin is particularly preferable.

In view of the strength, the material of the base material layer is more preferably at least one selected from the group consisting of non-woven fabric and woven fabric. Meanwhile, in view of easiness for adjusting physical properties, the material is more preferably rubber.

The thickness of the base material layer is preferably 80 to 1,800 μm, more preferably 100 to 1,400 μm, even more preferably 200 to 1,000 μm, and particularly preferably 300 to 800 μm. If the thickness is in the range described above, following properties to the pasted surface are more excellent, tear resistance and the piercing resistance are more excellent, and stumbling resistance at the time of being pasted on a floor or a road surface is excellent.

### <Protective Layer>

The sheet according to the invention has a pressure sensitive adhesive layer, a base material layer that is in contact with the pressure sensitive adhesive layer, and a protective layer of which a tensile elastic modulus is 1,000 MPa or greater, in this order.

The protective layer in the sheet according to the invention is a layer provided on an opposite side of the surface on which the pressure sensitive adhesive layer of the base material layer is provided, and the protective layer and the base material layer may directly come into contact with each other or may not come into contact with each other.

The protective layer of the sheet according to the invention is a layer that protects the sheet from abrasion and scratches, and tensile elastic modulus thereof is greater than that of the base material layer and is 1,000 MPa or greater.

The tensile elastic modulus of the protective layer according to the invention is 1,000 MPa or greater, preferably 1,000 to 10,000 MPa, more preferably 2,000 to 8,000 MPa, even more preferably 2,500 to 5,000 MPa, and particularly preferably 3,000 to 4,000 MPa. If the tensile elastic modulus is in the range described above, piercing resistance and following properties can be compatible with each other.

As described below, in a case where the protective layer described below has a laminate structure of two or more layers, the tensile elastic modulus of the protective layer is measured in the entire protective layer.

The material of the protective layer is preferably a resin, preferably a resin selected from the group consisting of polyethylene terephthalate (PET), polyethylene terephthalate (PET-G) obtained by partially copolymerizing cyclohexanedimethanol (copolycondensation), an acrylic resin, polycarbonate, polystyrene, nylon, and high density polyethylene (PE), and more preferably PET and/or PET-G.

As the resin used in the protective layer, a resin sheet is preferably used.

The protective layer more preferably includes at least PET, and particularly preferably includes PET and PET-G.

In view of increasing visibility of an image in an image layer described below, the protective layer is preferably a transparent layer, and more preferably a colorless transparent layer.

With respect to the transparency according to the invention, a transmittance of visible light (400 to 760 nm) is 80% or greater and preferably 90% or greater.

The protective layer may have a single layer structure or may be a laminate structure of two or more layers. However, the protective layer preferably has a laminate structure of two or more layers.

The protective layer preferably has at least a layer consisting of PET or PET-G, more preferably has at least a layer consisting of PET, and even more preferably has at least a layer consisting of PET and a layer consisting of PET-G.

In a case where the protective layer has a laminate structure of two or more layers, adhesive layers may be provided between the respective layers, in order to adhere the respective layers, if necessary.

An adhesive used in an adhesive layer in the protective layer is not particularly limited, and well-known adhesives or well-known pressure sensitive adhesives can be used.

The protective layer in the sheet according to the invention is preferably an outermost layer.

The protective layer preferably has an uneven structure on a front surface on the outermost layer side. If the protective layer has the form described above, strength becomes more excellent. In addition to the excellent strength, in a case where the sheet according to the invention is used as a floor sign, a slip is prevented in a case where the sheet according to the invention is stepped on, antislip properties that prevent falling or the like are also excellent.

The uneven structure is not particularly limited, and the uneven structure may be an irregular uneven structure or a regular uneven structure. A hemispherical uneven structure or an uneven structure of which a front surface portion in a cross section in a thickness portion of the protective layer is a trapezoid can be exemplified.

The thickness of the protective layer is preferably 20 to 1,000 μm, more preferably 50 to 600 μm, and even more preferably 100 to 400 μm. Even if the thickness is in the range described above, piercing resistance becomes more excellent, wear resistance is excellent, and stumbling resistance at the time of being pasted on a floor or a road surface is excellent.

As a thickness including a pressure sensitive adhesive layer, a base material layer, a protective layer, and arbitrary respective layers described below, a total thickness of the sheet according to the invention is preferably 100 to 2,500 μm, more preferably 150 to 2,000 μm, even more preferably 200 to 1,800 μm, and particularly preferably 500 to 1,800 μm. If the thickness is in the range described above, the strength becomes more excellent, durability is excellent, stumbling resistance at the time of being pasted on a floor or a road surface is excellent.

A shape of the sheet according to the invention in a plane shape is not particularly limited and can be caused to be an arbitrary shape and an arbitrary size, as desired. For example, in the case of a floor sign, the shape may be a square shape, a circular shape, or an arrow shape.

The sheet according to the invention may have another layer in addition to the pressure sensitive adhesive layer, the base material layer, and the protective layer, if necessary.

### <Image Layer>

It is preferable that the sheet according to the invention further has an image layer between the protective layer and the base material layer.

The image layer is a layer on which an image such as information such as advertising, direction indication, traffic flags, and a guidepost is formed, and may be a layer on which a desired image is formed.

The image layer may be a layer including an arbitrary image, but is preferably at least has an ink layer, more preferably consists of an ink layer and a polyvinyl chloride layer, and even more preferably consists of an ink layer and a white polyvinyl chloride layer.

The image layer may be formed on the entire surface on the base material layer and may not be formed. For example, a desired shape of an image may be formed on a base material layer.

With respect to unevenness generated in a case where the image layer is formed only on a portion of the base material layer or in a case where an image layer is not formed in an even thickness, it is preferable to flatten the unevenness with an adhesive layer described below.

The ink for forming the ink layer is not particularly limited, and may be a solvent ink, an aqueous ink, an ultraviolet curable-type ink, or a hybrid-type ink.

A color of the image in the image layer is not particularly limited, and may be an image of a single color, an image of two or more colors. The ink may use a single color or two or more colors.

A method of forming the image is not particularly limited. The image can be suitably formed by means of ink jet printing, screen printing, gravure printing, and thermal transfer printing, by using ink.

The image of the sheet according to the invention preferably has an opaque layer on the base material layer of the image layer, more preferably has a white layer, and even more preferably has a white polyvinyl chloride layer, so as not to influence the pasted surface.

The white layer preferably includes a white coloring agent, more preferably includes a white pigment, and even more preferably includes titanium oxide.

The thickness of the image layer is not particularly limited, but the thickness is preferably 10 to 200 μm and more preferably 20 to 100 μm.

In order to attach the image layer and the base material layer to each other, an adhesive layer may be provided between the image layer and the base material layer. The adhesive used in the adhesive layer is not particularly limited, and well-known adhesive or the well-known pressure sensitive adhesive can be used.

### <Adhesive Layer>

It is preferable that the sheet according to the invention further has an adhesive layer between the protective layer and the image layer.

The adhesive used in the adhesive layer between the protective layer and the image layer is not particularly limited, and well-known adhesives or well-known pressure sensitive adhesives can be used.

Among these, the pressure sensitive adhesive that can be used in the pressure sensitive adhesive layer can be suitably used. A rubber-based pressure sensitive adhesive, an acrylic pressure sensitive adhesive, an urethane-based pressure sensitive adhesive, a polyester-based pressure sensitive adhesive, and/or a silicone-based-based pressure sensitive adhesive can be more suitably used, and a rubber-based pressure sensitive adhesive or an acrylic pressure sensitive adhesive can be even more suitably used.

An adhesive layer between the protective layer and the image layer may be a layer made of the same material as the pressure sensitive adhesive layer.

In view of improving visibility of an image in the image layer, the adhesive layer between the protective layer and the image layer is preferably a transparent layer and more preferably a colorless transparent layer.

The thickness of the adhesive layer is preferably 5 to 300 μm, more preferably 10 to 250 μm, and even more preferably 15 to 200 μm.

### <Peeling Layer>

The sheet according to the invention preferably has a peeling layer on a surface opposite to a surface on which the base material layer of the pressure sensitive adhesive layer is provided.

The peeling layer is a layer that prevents the pressure sensitive adhesive layer from adhering to a portion other than a desired surface to which the sheet according to the invention is pasted. A release paper, a release film, a peeling paper, a peeling film, and a separator which are well known can be suitably used.

Examples of the peeling layer include a layer obtained by providing a release agent to paper or a resin film.

The release agent also relates to a material of the pressure sensitive adhesive layer, but well-known release agent can be used, and examples thereof preferably includes a silicone-based release agent or a fluorine-based release agent.

As the release film used in the peeling layer, a film obtained by coating a film base material such as polyester with a release agent such as silicone is suitably used.

Specific examples of the release film include CERAPEEL (registered trademark) WZ, CERAPEEL BKE, and CERAPEEL BX8A manufactured by Toray Advanced Film Co., Ltd.

The thickness of the peeling layer is preferably 10 to 500 μm, more preferably 30 to 300 μm, and even more preferably 50 to 200 μm.

The sheet according to the invention may have other layers in addition to the above.

For example, the sheet according to the invention may further have a peeling layer on the protective layer, such that scratches are not generated or dirt is not attached until being pasted as a floor sign or the like.

As the peeling layer on the protective layer, inserting paper, a resin film, release paper, a release film, peeling paper, a peeling film, and a separator which are well known can be suitably used.

Hereinafter, with reference to the drawings, sheet for application to a road surface, a floor, or a wall surface are further described.

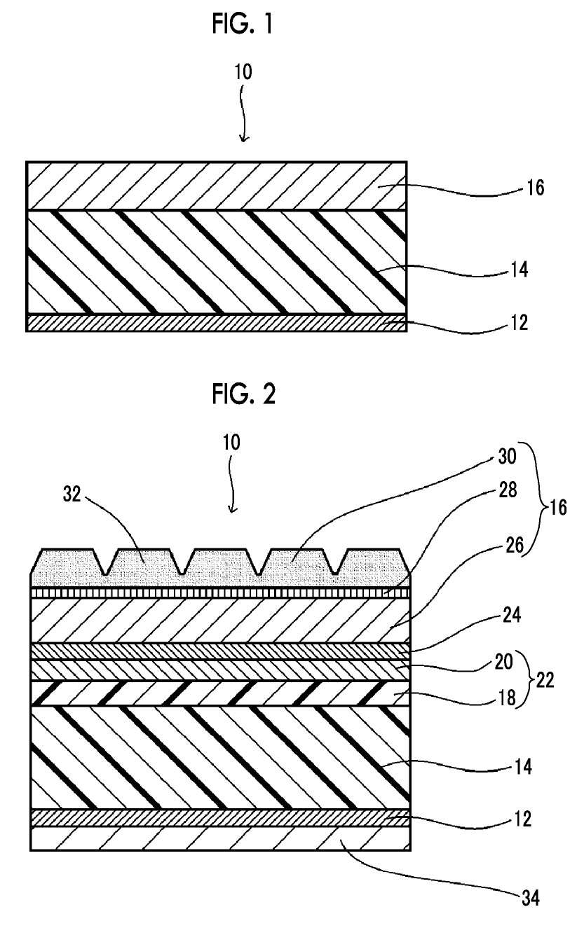

FIG. 1 is a diagram schematically illustrating a cross-section of an example of a sheet for application to a road surface, a floor, or a wall surface according to an embodiment of the invention.

A sheet for application to a road surface, a floor, or a wall surface 10 illustrated in FIG. 1 has a pressure sensitive adhesive layer 12, a base material layer 14 that is in contact with the pressure sensitive adhesive layer 12, and a protective layer 16 provided on an opposite side of the surface on which the pressure sensitive adhesive layer 12 of the base material layer 14 is provided.

When the sheet for application to a road surface, a floor, or a wall surface 10 illustrated in FIG. 1 is pasted on a road surface, a floor, or a wall surface, the pressure sensitive adhesive layer 12 is pasted so as to come into contact with the road surface, the floor, or the wall surface.

FIG. 2 is a diagram schematically illustrating a cross-section of an example of a sheet for application to a road surface, a floor, or a wall surface according to another embodiment of the invention.

The sheet for application to a road surface, a floor, or a wall surface 10 illustrated in FIG. 2 has the pressure sensitive adhesive layer 12, the base material layer 14 that is in contact with the pressure sensitive adhesive layer 12, and an image layer 22 consisting of a white polyvinyl chloride layer 18 and an ink layer 20 which is provided on an opposite side of the surface on which the pressure sensitive adhesive layer 12 of the base material layer 14 is provided. Though not illustrated in FIG. 2, an adhesive layer may be further provided between the white polyvinyl chloride layer 18 and the base material layer 14.

In the sheet for application to a road surface, a floor, or a wall surface 10 illustrated in FIG. 2, the protective layer 16 is provided on the image layer 22 via an adhesive layer 24. The protective layer 16 is formed in a laminate structure of three layers: a PET layer 26, an adhesive layer 28, and a PET-G layer 30, and an uneven structure 32 of which a cross section is a trapezoid is formed on the front surface of the PET-G layer 30.

The sheet for application to a road surface, a floor, or a wall surface 10 illustrated in FIG. 2 has a peeling layer 34 on a surface opposite to the surface on which the base material layer 14 of the pressure sensitive adhesive layer 12 is provided.

The sheet for application to a road surface, a floor, or a wall surface 10 illustrated in FIG. 2 is pasted on the road surface, the floor, or the wall surface, the peeling layer 34 is removed, and the sheet is pasted such that the pressure sensitive adhesive layer 12 is in contact with the road surface, the floor, or the wall surface. An image formed on the image layer 22 from the protective layer 16 side of the sheet for application to a road surface, a floor, or a wall surface 10 can be suitably recognized.

Since the uneven structure 32 is provided on the front surface of the protective layer 16, even in a case where the sheet is pasted on a road surface or a floor, strength or durability is more excellent, and also antislip properties that prevent falling or the like are also excellent.

### (Set for Forming Sheet for Application to Road Surface, Floor, or Wall Surface)

A set for forming the sheet for application to a road surface, a floor, or a wall surface according to the invention (hereinafter, simply referred to as a “set for forming the sheet according to the invention”) includes an image forming sheet that has a peeling layer, a pressure sensitive adhesive layer, and a base material layer which is in contact with the pressure sensitive adhesive layer and of which a tensile elastic modulus is 150 MPa or less, and an image forming layer, in this order; and a protective sheet that has a peeling layer, an adhesive layer, and a protective layer of which a tensile elastic modulus is 1,000 MPa or greater, in this order.

### <Image Forming Sheet>

The set for forming the sheet according to the invention includes an image forming sheet that has a peeling layer, a pressure sensitive adhesive layer, a base material layer which is in contact with the pressure sensitive adhesive layer and of which a tensile elastic modulus is 150 MPa or less, and an image forming layer, in this order.

The peeling layer, the pressure sensitive adhesive layer, and the base material layer in the image forming sheet have the same meaning as the peeling layer, the pressure sensitive adhesive layer, and the base material layer in the sheet according to the invention described above and preferable forms thereof are also the same.

The image forming layer in the image forming sheet is a layer for forming an image on the layer.

The sheet according to the invention can be manufactured by forming an image on the image forming layer, removing the peeling layer of the protective sheet, and adhering the image forming sheet on which the image is formed and the protective sheet from which the peeling layer is removed.

The image forming layer is not particularly limited. However, the image forming layer is preferably an opaque layer, more preferably a white layer, and even more preferably a white polyvinyl chloride layer.

The white layer is preferably includes a white coloring agent, more preferably includes a white pigment, and even more preferably includes titanium oxide.

The thickness of the image forming layer is not particularly limited. However, the thickness is preferably 5 to 200 μm and more preferably 10 to 100 μm.

In order to attach the image forming layer and the base material layer to each other, an adhesive layer may be provided between the image forming layer and the base material layer. The adhesive used in the adhesive layer is not particularly limited, and a well-known adhesive or a well-known pressure sensitive adhesive can be used.

The total thickness of the image forming sheet is preferably 100 to 2,000 μm, more preferably 200 to 1,800 μm, even more preferably 300 to 1,500 μm, and particularly preferably 500 to 1,500 μm.

### <Protective Sheet>

The set for forming the sheet according to the invention includes a protective sheet that has a peeling layer, an adhesive layer, and a protective layer of which a tensile elastic modulus is 1,000 MPa or greater, in this order.

The adhesive layer and the protective layer in the protective sheet have the same meaning as the adhesive layer and the protective layer between the protective layer and the image layer in the sheet according to the invention described above, and preferable forms thereof are also the same.

The peeling layer in the protective sheet is a layer that prevents the adhesive layer from adhering other than the image forming sheet, and release paper, a release film, peeling paper, a peeling film, and a separator, which are well known can be suitably used.

The peeling layer in the protective sheet have the same meaning as the same preferable form as the peeling layer in the sheet according to the invention described above.

The total thickness of the protective sheet is preferably 30 to 1,000 μm, more preferably 50 to 800 μm, even more preferably 100 to 600 μm, and particularly preferably 150 to 500 μm.

### EXAMPLES

The invention is described in detail with reference to examples below. Materials, amounts used, ratios, treatment details, and a treatment order provided in the examples below can be appropriately changed, without departing from the gist of the invention. Accordingly, the scope of the invention is not limited to specific examples described below.

In examples and comparative examples described below, “parts” and “%” mean “parts by mass” and “mass %”, unless described otherwise.

### <Method for Measuring Tensile Elastic Modulus>

The tensile elastic modulus of the respective layers is calculated by performing a test in conformity with JIS K 7161.

### Example 1

One surface of an NBR base material layer (manufactured by Irumagawa Rubber Co., Ltd., IN-80) of which a tensile elastic modulus was 5 MPa, and a thickness was 500 was coated with a rubber-based pressure sensitive adhesive (styrene-isoprene copolymer), and a separator (manufactured by Sun A. Kaken Co. Ltd., SK SEPARATOR, RFE100N) was attached. Black printing was performed by using a solvent-based printing machine (manufactured by Mimaki Engineering Co., Ltd., JV5-1605) on a white polyvinyl chloride layer of the sheet completed by adhering a white polyvinyl chloride layer (manufactured by Lintec Corporation, GIY-11Z5) having a thickness of 80 μm on an opposite side to the pressure sensitive adhesive layer. A PET protective layer (tensile elastic modulus: 3,500 MPa, thickness: 188 μm, manufactured by Toyobo Co., Ltd., COSMOSHINE (registered trademark) A4300) that was coated with the pressure sensitive adhesive layer was adhered to a printing surface, so as to manufacture a test sample (sheet for application to a road surface, a floor, or a wall surface).

The thickness of the obtained adhering test was 950 μm.

Respective evaluations were performed in the following methods by using the obtained adhering test sample. The evaluation results are presented in Table 1.

### <Evaluation of Following Properties>

An asphalt surface was coated with a synthetic rubber-based primer and air-dried, a separator of the sample was removed, and a surface of the pressure sensitive adhesive layer was brought into contact with the sample. Thereafter, the surface of the protective layer of the sample was beat by a rubber hammer, tint on the surface of the protective layer after pressure was applied was observed. If peeling between respective layers, particularly, between the protective layer and the image layer was generated, the same turned white.

Evaluation standards were as below.

A: Tint changes were hardly generated, and were satisfactory.

B: Tint changes were less than 5% of the area.

C: Tint changes were 5% or greater and less than 10% of the area.

D: Tint changes were 10% or greater of the area.

### <Strength Evaluation>

—Tear resistance evaluation—

In the tear resistance evaluation, in conformity with JIS K 7128, a tear strength test was performed by using a tensile testing machine (manufactured by A&D Company, Limited, RTF-1310), so as to calculate a value of the tear strength. Evaluation standards were as below.

A: A value of the tear strength was 35 N or greater.

B: A value of the tear strength was 30 N or greater and less than 35 N.

C: A value of the tear strength was 20 N or greater and less than 30 N.

D: A value of the tear strength was less than 20 N.

—Piercing resistance evaluation—

In the piercing resistance evaluation, in conformity with JIS Z 1707, an indentation strength test was performed by using a thrust indentation testing machine (manufactured by A&D Company, Limited, RTF-1310), so as to calculate a value of the indentation strength. Evaluation standards were as below.

A: A value of the indentation strength was 50 N or greater.

B: A value of the indentation strength was 40 N or greater and less than 50 N.

C: A value of the indentation strength was 30 N or greater and less than 40 N.

D: A value of the indentation strength was less than 30 N.

### Examples 2 to 13 and Comparative Examples 1 to 4

In the same manner as in Example 1 except for changing configurations of the respective layers to those presented in Table 1, adhering test samples (sheets for application to a road surface, a floor, or a wall surface) according to Examples 2 to 13 and Comparative Examples 1 to 4 were respectively manufactured.

Respective evaluations below were performed in the same manner as in Example 1 by using the obtained adhering test samples. Evaluation standards were as in Table 1 below.

TABLE 1

| | | | | | Material of | Thickness of | | Tensile | | | |
|---|---|---|---|---|---|---|---|---|---|---|---|
| | | Thickness | Tensile elastic | | pressure | pressure | | elastic | | | |
| | Material of | of base | modulus of | | sensitive | sensitive | Material of | modulus of | | Tear | Piercing |
| | base material | material | base material | | adhesive | adhesive | protective | protective | Following | resis- | resis- |
| | layer | layer | layer | | layer | layer | layer | layer | properties | tance | tance |
| Example 1 | NBR | 500 μm | 5 | MPa | Rubber-based | 110 μm | PET | 3,500 MPa | A | A | A |
| Example 2 | NBR | 500 μm | 60 | MPa | Rubber-based | 110 μm | PET | 3,500 MPa | A | A | A |
| Example 3 | Natural rubber | 500 μm | 60 | MPa | Rubber-based | 110 μm | PET | 3,500 MPa | A | A | A |
| Example 4 | Polyester | 400 μm | 100 | MPa | Rubber-based | 110 μm | PET | 3,500 MPa | A | A | A |
| | non-woven | | | | | | | | | | |
| | fabric | | | | | | | | | | |
| Example 5 | Tarpaulin | 400 μm | 50 | MPa | Rubber-based | 110 μm | PET | 3,500 MPa | A | A | A |
| Example 6 | NBR | 200 μm | 60 | MPa | Rubber-based | 110 μm | PET | 3,500 MPa | B | B | B |
| Example 7 | NBR | 100 μm | 60 | MPa | Rubber-based | 110 μm | PET | 3,500 MPa | C | C | B |
| Example 8 | NBR | 500 μm | 60 | MPa | Rubber-based | 50 μm | PET | 3,500 MPa | B | A | A |
| Example 9 | NBR | 500 μm | 60 | MPa | Rubber-based | 30 μm | PET | 3,500 MPa | C | A | A |
| Example 10 | NBR | 500 μm | 60 | MPa | Rubber-based | 110 μm | PC | 2,000 MPa | A | A | B |
| Example 11 | NBR | 500 μm | 60 | MPa | Rubber-based | 110 μm | High density | 1,300 MPa | A | A | C |
| | | | | | | | PE | | | | |
| Example 12 | NBR | 500 μm | 60 | MPa | Rubber-based | 110 μm | Laminate of | 3,000 MPa | A | A | A |
| | | | | | | | PET/PET-G | | | | |
| Example 13 | NBR | 500 μm | 5 | MPa | Acrylic | 50 μm | PET | 3,500 MPa | B | A | A |
| Comparative | PET | 188 μm | 3,500 | MPa | Rubber-based | 110 μm | PET | 3,500 MPa | D | D | A |
| Example 1 | | | | | | | | | | | |
| Comparative | NBR | 500 μm | 60 | MPa | Rubber-based | 110 μm | Soft polyvinyl | 240 MPa | A | A | D |
| Example 2 | | | | | | | chloride | | | | |
| Comparative | Lenticular | 350 μm | 3,000 | MPa | Rubber-based | 110 μm | PET | 3,500 MPa | D | D | A |
| Example 3 | sheet (PET) | | | | | | | | | | |
| Comparative | Soft polyvinyl | 500 μm | 240 | MPa | Rubber-based | 110 μm | PET | 3,500 MPa | D | A | A |
| Example 4 | chloride | | | | | | | | | | |

Among the configurations of the respective layers presented in Table 1, details in addition to the description above were as follows.

Natural rubber: NR sheet <60> manufactured by Tigers Polymer Corporation

Polyester non-woven fabric: 80906GSE manufactured by Unitika Ltd.

Tarpaulin: woven fabric, ME-400 manufactured by Kuraray Co., Ltd.

NBR (tensile elastic modulus: 60 MPa): NBR SHEET-L <90> manufactured by Tigers Polymer Corporation

NBR (thickness: 200 μm): IN-80 manufactured by Irumagawa Rubber Co., Ltd.

NBR (thickness: 100 μm): IN-80 manufactured by Irumagawa Rubber Co., Ltd.

PET (for a base material layer of Comparative Example 1): COSMOSHINE (registered trademark) A4300 manufactured by Toyobo Co., Ltd.

Lenticular sheet: 150LPI (PET) manufactured by Coburn Japan Corporation

PC: A polycarbonate film having a thickness of 200 μm was manufactured with an extrusion film forming device.

High density PE: A high density polyethylene film having a thickness of 200 μm was manufactured with an extrusion film forming device.

Laminate of PET/PET-G: A laminate obtained by laminating a PET-G+ adhesive layer on a PET film having a thickness of 188 μm by a thickness of 100 μm with a melting laminate device was used.

Soft polyvinyl chloride: MAJIKILY II manufactured by Achilles Corporation, thickness of 500 μm

Acrylic pressure sensitive adhesive: ORIBAIN BPS6080TFK manufactured by Toyochem Co., Ltd.

As presented in Table 1, with respect to Examples 1 to 13 satisfying the invention, following properties to a pasted surface were excellent, tear resistance and piercing resistance were excellent, and following properties and strength were compatible with each other.

In contrast, in Comparative Example 1, since a tensile elastic modulus of the base material layer was extremely great, and flexibility is low, following properties were bad. Since the thickness of the base material layer was thin, tear resistance was also bad. In Comparative Example 2, since a tensile elastic modulus of the protective layer was small, piercing resistance was bad. In Comparative Example 3, since a tensile elastic modulus of the base material layer was extremely great and flexibility was low in the same manner as in Comparative Example 1, following properties were bad, and tear resistance was also bad. In Comparative Example 4, a tensile elastic modulus of the base material layer was great, and following properties was bad.

### EXPLANATION OF REFERENCES

10: sheet for application to a road surface, a floor, or a wall surface
12: pressure sensitive adhesive layer
14: base material layer
16: protective layer
18: white polyvinyl chloride layer
20: ink layer
22: image layer
24: adhesive layer
26: PET layer
28: adhesive layer
30: PET-G layer
32: uneven structure
34: peeling layer

What is claimed is:

1. A sheet for application to a road surface, a floor, or a wall surface, comprising:
a pressure sensitive adhesive layer;
a base material layer that is in contact with the pressure sensitive adhesive layer and of which a tensile elastic modulus is 150 MPa or less; and
a protective layer of which a tensile elastic modulus is 1,000 MPa or greater, in this order.

2. The sheet according to claim 1,
wherein a thickness of the base material layer is 200 to 1,000 μm.

3. The sheet according to claim 1,
wherein a thickness of the pressure sensitive adhesive layer is 50 to 200 μm.

4. The sheet according to claim 1,
wherein a material of the base material layer is at least one selected from the group consisting of rubber, a non-woven fabric, and a woven fabric.

5. The sheet according to claim 1, further comprising:
an image layer between the protective layer and the base material layer.

6. The sheet according to claim 5, further comprising:
an adhesive layer between the protective layer and the image layer.

7. The sheet according to claim 1,
wherein the protective layer has a laminate structure of two or more layers.

8. The sheet according to claim 1,
wherein a tensile elastic modulus of the base material layer is 2 to 120 MPa.

9. The sheet according to claim 1,
wherein a tensile elastic modulus of the protective layer is 2,500 to 5,000 MPa.

10. The sheet according to claim 1,
wherein a material of the protective layer includes at least polyethylene terephthalate.

11. The sheet according to claim 1,
wherein the protective layer includes at least a layer that consists of polyethylene terephthalate and a layer that consists of poly(ethylene glycol-co-cyclohexanedimethanol terephthalate).

12. The sheet according to claim 1,
wherein a material of the base material layer includes non-woven fabric or woven fabric.

13. The sheet according to claim 1, which is a sheet for application to a road surface or a floor.

14. A set for forming a sheet for application to a road surface, a floor, or a wall surface, comprising:
an image forming sheet including
a peeling layer,
a pressure sensitive adhesive layer,
a base material layer that is in contact with the pressure sensitive adhesive layer and of which a tensile elastic modulus is 150 MPa or less, and
an image forming layer, in this order; and
a protective sheet including
a peeling layer,
an adhesive layer, and
a protective layer of which a tensile elastic modulus is 1,000 MPa or greater, in this order.
